(19) United States
(12) Patent Application Publication
(10) Pub. No.: US 2007/0140346 A1
(43) Pub. Date: Jun. 21, 2007

(54) Frame interpolator, frame interpolation method and motion reliability evaluator

(75) Inventors: Han-Feng Chen, Suwon-si (KR); Sung-Soo Kim, Suwon-si (KR); Jun-Ho Sung, Seoul (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/600,744

(22) Filed: Nov. 17, 2006

(30) Foreign Application Priority Data
Nov. 25, 2005 (KR) 2005-0113660

(51) Int. Cl. H04N 11/02; H04N 7/12

(52) U.S. Cl. 375/240.16; 375/240.26

(57) ABSTRACT

A frame interpolator comprises a motion estimating unit dividing a current frame into a plurality of reference blocks, each reference block having a predetermined size, comparing the reference block with a predetermined search area set in a previous frame, and estimating an initial motion vector. A reliability evaluating unit evaluates reliability of the initial motion vector and generates reliability evaluation data regarding the evaluation result. A frame interpolating unit interpolates an intermediate frame to be inserted between the current frame and the previous frame on the basis of the initial motion vector and the reliability evaluation data A frame interpolator, a frame interpolation method, and a motion reliability evaluator, which are capable of improving interpolation quality of frames and reducing a block artifact, are provided.

### CROSS-REFERENCE TO RELATED APPLICATIONS

This application claims the benefit under 35 U.S.C. § 119(a) from Korean Patent Application No.2005-0113660, filed on Nov. 25, 2005, in the Korean Intellectual Property Office, the entire contents of which are hereby incorporated by reference.

### BACKGROUND OF INVENTION

1. Field of Invention

The present invention relates to a frame interpolator, a frame interpolation method and a motion reliability evaluator. More particularly, the present invention relates to a frame interpolator, a frame interpolation method and a motion reliability evaluator, using motion vector estimation and motion compensation.

2. Description of the Related Art

In general, frame rate conversion means convert a frequency of an input image signal into a frequency suitable for an output standard. For example, in order to convert a frequency of 50 Hz of an image signal into a frequency of 100 Hz, new frames are inserted between original frames. At this time, if the original frames are repeated or a temporal linear interpolation method is used, a motion blur (motion fadeout phenomenon) occurs. For this reason, a motion estimation and compensation method is generally used as a high definition frame rate conversion method to effectively reduce such a motion blur.

In order to interpolate frames using this motion estimation and compensation method, various interpolation methods are actively developed. As one of such interpolation methods, a block matching method is widely used.

In frame interpolation, correctly estimating motion vectors is very important. If motion vectors are incorrectly estimated, a block artifact occurs in the interpolated frames. As described above, although many frame interpolation methods using motion estimation and compensation have been developed and proposed, sometimes, incorrect motion vectors may be estimated due to noise disturbance of signals, the aperture problem, and so on.

Also, the block artifact may be generated because blocks disposed at the same location in a current frame and an interpolated frame have different motion vectors due to time difference. If a motion vector estimated in a current frame is directly used as a motion vector of the corresponding interpolated frame, the block artifact will be generated.

### SUMMARY OF THE INVENTION

Accordingly, it is an aspect of the exemplary embodiments of the present invention to provide a frame interpolator, a frame interpolation method, and a motion reliability evaluator, which are capable of improving interpolation quality of frames and reducing a block artifact.

The foregoing and/or other exemplary aspects of the exemplary embodiments of the present invention are facilitated by providing a frame interpolator comprising a motion estimating unit dividing a current frame into a plurality of reference blocks, each reference block having a certain size. The reference block is compared with a search area set in a previous frame, and an initial motion vector is estimate. A reliability evaluating unit is provided for evaluating reliability of the initial motion vector and generating reliability evaluation data regarding the evaluation result. A frame interpolating unit interpolates an intermediate frame to be inserted between the current frame and the previous frame on the basis of the initial motion vector and the reliability evaluation data.

According to an aspect of an exemplary embodiment of the present invention, the reliability evaluating unit comprises a smoothing block detecting unit determining whether the reference block is a smoothing block, a periodic block detecting unit determining whether the reference block is a periodic block, and a reliability generating unit generating the reliability evaluation data according to the detection results.

According to an aspect of an exemplary embodiment of the present invention, the smoothing block detecting unit determines whether the reference block is the smoothing block according to the following Equation:

$${S}_{e} < Thr 2 and {S}_{d} < Thr 3$$

$$\{ {P}_{mn} ( i , j ) \vert 0 \leq i \leq {M}_{b} - 1 , 0 \leq j \leq {N}_{b} - 1 \} . \\ where , \\ {S}_{e} = {\sum }_{{0 \leq i \leq {M}_{b} - 2}_{0 \leq j \leq {N}_{b} - 2}} f ( i , j )$$

$$f ( i , j ) = \{ \begin{matrix}1 & if \vert {P}_{mn} ( i , j ) - {P}_{mn} ( i , j + 1 ) \vert + \vert {P}_{mn} ( i , j ) - {P}_{mn} ( i + 1 , j ) \vert > Thr 1 \\ 0 & else\end{matrix} \\ and \\ {S}_{d} = {\sum }_{{0 \leq i \leq {M}_{b} - 2}_{0 \leq j \leq {N}_{b} - 2}} ( \vert {P}_{mn} ( i , j ) - {P}_{mn} ( i , j + 1 ) \vert + \vert {P}_{mn} ( i , j ) - {P}_{mn} ( i + 1 , j ) \vert )$$

wherein Thr1, Thr2, and Thr3 represent reference values.

According to an aspect of an exemplary embodiment of the present invention, the periodic block detecting unit determines that the reference block is the periodic block if the following four inequalities are satisfied:
1)|SAD_{c}(p₁,q₁)−SAD_{c}(p₀,q₀)|<Thr4;
2)|p₁−p₀|+|q₁−q₀|>Thr5;
3)SAD_{c}(p₁,q₁)<SAD_{c}(p₁−1,q₁),SAD_{c}(p₁,q₁)<SAD_{c}(p₁,q₁−1),
SAD_{c}(p₁,q₁)<SAD_{c}(p₁+1,q₁),SAD_{c}(p₁,q₁)<SAD_{c}(p₁,q₁+1);
4)SAD_{c}((p₁+p₀)/2,(q₁+q₀)/2)>Thr6*SAD_{c}(p₀,q₀);

According to an aspect of an exemplary embodiment of the present invention, the frame interpolating unit interpolates the intermediate frame according to a symmetrical block matching method.

According to an aspect of an exemplary embodiment of the present invention, the frame interpolating unit comprises a motion selecting unit deciding a final motion vector on the basis of the initial motion vector and the reliability evaluation data, and a motion compensating unit interpolating the intermediate frame to be inserted between the current frame and the previous frame according to the decided final motion vector.

According to an aspect of an exemplary embodiment of the present invention, the motion selecting unit comprises a candidate generating unit for generating a plurality of candidate vectors on the basis of the initial motion vector and the reliability evaluation data.

According to an aspect of an exemplary embodiment of the present invention, the candidate generating unit comprises a first candidate generating unit generating the plurality of candidate vectors on the basis of the initial motion vector and the reliability evaluation data, and a second candidate generating unit generating the plurality of candidate vectors on the basis of motion vectors of previous-interpolated adjacent blocks and a motion field of a previously interpolated frame.

According to an aspect of an exemplary embodiment of the present invention, the first candidate generating unit comprises an area selecting unit selecting a plurality of predetermined areas respectively corresponding to the plurality of candidate vectors in an initial motion vector field, a median filter performing median-filtering on a first area of the predetermined areas, and generating a first candidate vector, a first SAD calculator calculating a minimum SAD value from a second area of the predetermined areas, and generating a second candidate vector, a second SAD calculator calculating a minimum SAD value from a third area of the predetermined area, and generating a third candidate vector, and a third SAD calculator calculating a minimum SAD value from a fourth area of the predetermined areas, and generating a fourth candidate vector.

According to an aspect of an exemplary embodiment of the present invention, the first area is defined as follows:
{BMVₖ(m+x,n+y)εSP₁|−2≦x≦2,−2≦y≦2}

where BMVₖ represents the initial motion vector field, k represents a frame number, SP₁ represents the first area, and the coordination value (m+x,n+y) represents each location of upper and left pixels of the block.

According to an aspect of an exemplary embodiment of the present invention, the second area is defined as follows:
{BMVₖ(m+x,n+y)εSP′₁|BMVₖ(m+x,n+y)εSP₁,Cₖ(m+x,n+y)=0,−2≦x≦2,−2≦y≦2}
where SP′₁ represents the second area, Cₖ(m+x,m+y)=0 means that the corresponding block is not in a smoothing area and is not in a periodic area, and the second area SP′₁ is a part of the first area SP₁.

According to an aspect of the present invention, the third area is defined as follows:
{BMVₖ(m+x,n+y)εSP₂|−1≦x≦1,−1≦y≦1}

where SP₂ represents the third area.

According to an aspect of the present invention, the fourth area is defined as follows:
{BMVₖ(m+x,n+y)εSP′₂|BMVₖ(m+x,n+y)εSP₂,Cₖ(m+x,n+y)=0,−1≦x≦1,−1≦y≦1}
where SP′₂ represents the fourth area, Cₖ(m+x,n+y)=0 means that the corresponding block is not in the smoothing area and is not in the periodic area, and SP′₂ is a part of the third area SP₂.

According to an aspect of an exemplary embodiment of the present invention, the second candidate generating unit selects a motion vector of a left adjacent block of the reference block as a fifth candidate vector, selects a motion vector of an upper adjacent block of the reference block as a sixth candidate vector, and selects a motion vector of a lower and right adjacent block of the reference block as a seventh candidate vector in the previously interpolated frame.

According to an aspect of an exemplary embodiment of the present invention, the motion selecting unit comprises a first final candidate selecting unit deciding one of the plurality of candidate vectors generated from the first candidate generating unit as a first final candidate vector, according to a first selection criterion, a second final candidate selecting unit deciding one of the plurality of candidate vectors generated from the second candidate generating unit as a second final candidate vector, according to a second selection criterion, and a final vector deciding unit selecting one of the first final candidate vector and the second final candidate vector as a final motion vector, according to a third selection criterion.

According to an aspect of an exemplary embodiment of the present invention, the first selection criterion is defined as follows:
if (SAD_{C1}<Thr7) or (SAD_{C1}<SAD_{C3}+Thr8),V₁=CV₁;
else if (K_{C4}<5) and ((SAD_{C2}<Thr7) or (SAD_{C2}<SAD_{C2}+Thr8)), V₁=CV₂;
else if (K_{C4}>5) and ((SAD_{C4}<Thr7) or (SAD_{C4}<SAD_{C3}+Thr8)),V₁=CV₄;
else V₁=CV₃;

where, SAD_{C1} represents a minimum SAD value by the first candidate vector, SAD_{C2} represents a minimum SAD value by the second candidate vector, SAD_{C3} represents a minimum SAD value by the third candidate vector, SAD_{C4} represents a minimum SAD value by the fourth candidate vector, K_{C4} is the number of motion vectors, Thr7 and Thr8 represent reference values, CV₁, CV₂, CV₃, and CV₄ respectively represent the first candidate vector, the second candidate vector, the third candidate vector, and the fourth candidate vector, and V₁ represents the first final candidate vector.

According to an aspect of an exemplary embodiment of the present invention, the second selection criterion depends on a minimum SAD value according to a symmetrical block matching method.

According to an aspect of an exemplary embodiment of the present invention, the third selection criterion is defined as follows:
if (|V₁−CV₅|>Thr9) and (|V₁−CV₆|>Thr9) and (|V₁−CV₇|>Thr9)
and ((SAD_{V2}<Thr7) or (SAD_{V2}<SAD_{V1}+Thr8)),BMV_{k-0.5}(m,n)=V₂;
else BMV_{k-0.5}(m,n)=V₁;
where, SAD_{C5} represents a minimum SAD value by the fifth candidate vector, SAD_{C6} represents a minimum SAD value by the sixth candidate vector, SAD_{C7} represents a minimum SAD value by the seventh candidate vector, Thr7, Thr8, and Thr9 represent reference values, CV₅, CV₆, and CV₇ respectively represent the fifth candidate vector, the sixth candidate vector, and the seventh candidate vector, V₁ represents the first final candidate vector, and V₂ represents the second final candidate vector.

According to an aspect of an exemplary embodiment of the present invention, the frame interpolating unit interpolates the intermediate frame by the following Equation:
if (SAD_{V}<Thr10),B_{k-0.5}(m,n)=B′ₖ(m,n);
else B_{k-0.5}(m,n)=(B′ₖ(m,n)+B′ₖ₋₁(m,n))/2;

where, SAV_{V} represents a minimum SAD value by the final motion vector, Thr10 represents a reference value, B_{k-0.5}(m,n) represents a block to be interpolated, B′ₖ(m,n) represents a matching block of the current frame, and B′ₖ₋₁(m,n) represents a matching block of the previous frame.

According to an aspect of an exemplary embodiment of the present invention, the motion estimating unit estimates the initial motion vector according to a full search block matching algorithm.

The foregoing and/or other aspects of the exemplary embodiments of present invention can be facilitated by providing a frame interpolation method comprising dividing a current frame into a plurality of reference blocks, each reference block having a predetermined size, comparing the reference block with a predetermined search area set in a previous frame, and estimating an initial motion vector. The reliability of the initial motion vector is evaluated and reliability evaluation data regarding the evaluation result is generated. An intermediate frame is interpolated to be inserted between the current frame and the previous frame on the basis of the initial motion vector and the reliability evaluation data.

According to an aspect of an exemplary embodiment of the present invention, the generating of the reliability evaluation data comprises determining whether the reference block is a smoothing block, determining whether the reference block is a periodic block, and generating the reliability evaluation data according to the determined results.

According to an aspect of an exemplary embodiment of the present invention, in the interpolating of the intermediate frame, the intermediate frame is interpolated according to a symmetrical block matching method.

According to an aspect of an exemplary embodiment of the present invention, the interpolating the intermediate frame comprises deciding a final motion vector on the basis of the reliability evaluation data, and interpolating the intermediate frame to be inserted between the current frame and the previous frame according to the final motion vector.

According to an aspect of an exemplary embodiment of the present invention, the deciding the finial motion vector comprises generating a plurality of candidate vectors on the basis of the initial motion vector and the reliability evaluation data, and deciding one of the plurality of candidate vectors as a final motion vector according to a certain criterion.

According to an aspect of an exemplary embodiment of the present invention, the generating the plurality of candidate vectors comprises generating a plurality of first candidate vectors on the basis of the initial motion vector and the reliability evaluation data, and generating a plurality of second candidate vectors on the basis of motion vectors of previous-interpolated adjacent blocks and a motion field of a previously interpolated frame.

According to an aspect of an exemplary embodiment of the present invention, the generating of the plurality of first candidate vectors comprises selecting a plurality of areas respectively corresponding to the plurality of candidate vectors in an initial motion vector field, performing median-filtering on a first area of the selected plurality of areas and generating a first candidate vector, calculating a minimum SAD value from a second area of the selected plurality of areas and generating a second candidate vector, calculating a minimum SAD value from a third area of the predetermined areas and generating a third candidate vector, and calculating a minimum SAD value from the fourth area of the predetermined areas and generating a fourth candidate vector.

According to an aspect of an exemplary embodiment of the present invention, the generating the plurality of second candidate vectors comprises selecting a motion vector of a left adjacent block of the reference block, as a fifth candidate vector; selecting a motion vector of a upper adjacent block of the reference block, as a sixth candidate vector, and selecting a motion vector of a lower and right adjacent block of the reference block, as a seventh candidate vector, in the previously interpolated frame.

According to an aspect of an exemplary embodiment of the present invention, the deciding the final motion vector comprises selecting one of the plurality of candidate vectors generated from the first candidate generating unit as a first final candidate vector, according to a first selection criterion, selecting one of the plurality of candidate vectors generated from the second candidate generating unit as a second final candidate vector, according to a second selection criterion, and deciding one of the first final candidate vector and the second candidate vector as the final motion vector, according to a third selection criterion.

The foregoing and/or other aspects of the exemplary embodiments of the present invention can be facilitated by providing a motion reliability evaluator comprising a motion estimating unit dividing a current frame into a plurality of reference blocks, each reference block having a predetermined size, comparing the reference block with a predetermined search area set in a previous frame, and estimating an initial motion vector, a periodic block detecting unit determining whether the reference block is a periodic block, and a reliability generating unit generating reliability evaluation data according to the determined result.

According to an aspect of an exemplary embodiment of the present invention, the periodic block detecting unit determines that the reference block is the periodic block if the following four inequalities are satisfied:
1)|SAD_{c}(p₁,q₁)−SAD_{c}(p₀,q₀)|<Thr4;
2)|p₁−p₀|+|q₁−q₀|>Thr5;
3)SAD_{c}(p₁,q₁)<SAD_{c}(p₁−1,q₁),SAD_{c}(p₁,q₁)<SAD_{c}(p₁,q₁−1),
SAD_{c}(p₁,q₁)<SAD_{c}(p₁+1,q₁),SAD_{c}(p₁,q₁)<SAD_{c}(p₁,q₁+1);
4)SAD_{c}((p₁+p₀)/2,(q₁+q₀)/2)>Thr6*SAD_{c}(p₀,q₀);

According to an aspect of an exemplary embodiment of the present invention, the motion reliability evaluator further comprises a smoothing block detecting unit determining whether the reference block is a smoothing block.

According to an aspect of an exemplary embodiment of the present invention, the smoothing block detecting unit determines whether the reference block is the smoothing block, according to the following Equation:

$${S}_{e} < Thr 2 and {S}_{d} < Thr 3$$

$$\{ {P}_{mn} ( i , j ) \vert 0 \leq i \leq {M}_{b} - 1 , 0 \leq j \leq {N}_{b} - 1 \} . \\ where , \\ {S}_{e} = {\sum }_{{0 \leq i \leq {M}_{b} - 2}_{0 \leq j \leq {N}_{b} - 2}} f ( i , j )$$

$$f ( i , j ) = \{ \begin{matrix}1 & if \vert {P}_{mn} ( i , j ) - {P}_{mn} ( i , j + 1 ) \vert + \vert {P}_{mn} ( i , j ) - {P}_{mn} ( i + 1 , j ) \vert > Thr 1 \\ 0 & else\end{matrix} \\ and \\ {S}_{d} = {\sum }_{{0 \leq i \leq {M}_{b} - 2}_{0 \leq j \leq {N}_{b} - 2}} ( \vert {P}_{mn} ( i , j ) - {P}_{mn} ( i , j + 1 ) \vert + \vert {P}_{mn} ( i , j ) - {P}_{mn} ( i + 1 , j ) \vert )$$

wherein Thr1, Thr2, and Thr3 represent reference values.

### BRIEF DESCRIPTION OF THE DRAWINGS

The above and/or other aspects and advantages of exemplary embodiments of the prevent invention will become apparent and more readily appreciated from the following description of the exemplary embodiments, taken in conjunction with the accompany drawings, in which:

FIG. 1 is a control block diagram of a frame interpolator according to an exemplary embodiment of the present invention;

FIGS. 2A and 2B are views for explaining a motion interpolation method performed by the frame interpolator, according to an exemplary embodiment of the present invention;

FIG. 3 is a control block diagram of a motion selecting unit illustrated in FIG. 1, according to an exemplary embodiment of the present invention;

FIG. 4 is a control block diagram of a first candidate generating unit illustrated in FIG. 3, according to an exemplary embodiment of the present invention; and

FIG. 5 is a view for explaining a location relationship of candidate vectors selected by a second candidate generating unit illustrated in FIG. 3, according to an exemplary embodiment of the present invention.

### DESCRIPTION OF EXEMPLARY EMBODIMENTS

Reference will now be made in detail to exemplary embodiments of the present invention, examples of implementations of which are illustrated in the accompanying drawings. These exemplary embodiments are described below to facilitate the understanding of certain exemplary aspects of the present invention with reference to the drawing figures.

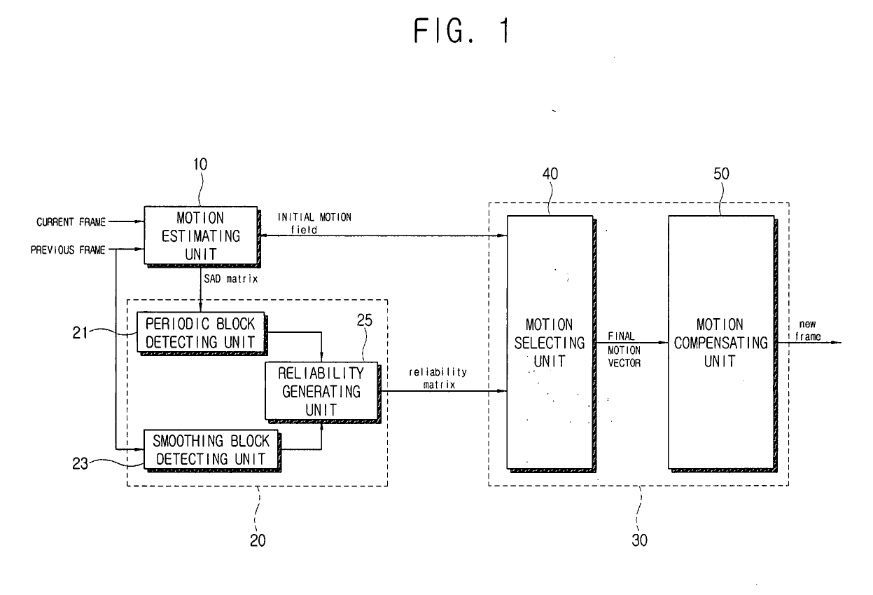

FIG. 1 is a control block diagram of a frame interpolator according to an exemplary embodiment of the present invention.

Referring to FIG. 1, the frame interpolator includes a motion estimating unit 10, a reliability evaluating unit 20, and a frame interpolating unit 30.

In order to obtain an initial motion field BMVₖ of a current frame Fₖ, the motion estimating unit 10 divides the current frame Fₖ into a plurality of blocks, each block indexed as Bₖ(m,n) having a certain size, and compares a block (hereinafter, referred to as a “reference block”) whose motion will be estimated in the current frame Fₖ with a search area of the previous frame Fₖ₋₁, thus estimating an initial motion vector BMVₖ(m,n). In an exemplary implementation, the motion estimating unit 10 calculates a plurality of motion prediction error values using a Full Search Block Matching (FSBM) algorithm. Also, the motion estimating unit 10 estimates motion vectors of respective blocks from a location having a minimum motion prediction error value. The motion prediction error values can be calculated by various methods, such as a Sum of Absolute Difference (SAD) method or a Mean Absolute Difference (MAD) method.

In an exemplary implementation, “k” is a serial number of a frame and a block size can be variously set, such as 16×8, 8×8, etc. In an exemplary embodiment, the block size is set to M_{b}*N_{b}.

The motion estimating unit 10 searches a matched block B′mn from the previous frame Fₖ₋₁, with respect to each block Bₖ(m,n) of the current frame Fₖ, in a search area as defined below, on the basis of a SAD method defined below as Equation 1, according to the FSBM algorithm.

$$\{ ( p , q ) ∈ {R}_{m} \vert 0 \leq p \leq {M}_{s} - 1 , 0 \leq q \leq {N}_{s} - 1 \} \\ SAD ( {d}_{1} , {d}_{2} ) = {\sum }_{( i , j ) ∈ {B}_{k} ( m , n )} \vert {F}_{k} ( m \times {M}_{b} + i , n \times {N}_{b} + j ) - {F}_{k - 1} ( m \times {M}_{b} + i + {d}_{1} , n \times {N}_{b} + j + {d}_{2} ) \vert \qquad ( 1 )$$

where (d1, d2) means a displacement between the block Bₖ(m,n) of the current frame Fₖ and the reference block B′mn of the previous frame Fₖ₋₁. That is, a displacement between two matched blocks Bₖ(m,n) and B′mn is set to an initial motion vector BMVₖ(m,n) of the block Bₖ(m,n). The initial motion vector BMVₖ(m,n) is defined as the following Equation 2.

$${BMV}_{k} ( m , n ) = ( {d}_{mn}^{h} , {d}_{mn}^{v} ) = arg {min}_{( {d}_{1} , {d}_{2} ) ∈ {R}_{mn}} SAD ( {d}_{1} , {d}_{2} ) \qquad ( 2 )$$

If the motion estimating unit 10 estimates the initial motion vector BMVₖ(m,n), the reliability evaluating unit 20 evaluates reliability of the estimated initial motion vector BMVₖ(m,n), as illustrated in FIG. 1. The FSBM algorithm as described above searches all possible candidate locations from the previous frame Fₖ₋₁ in order to detect a reference block optimally matched to each block of the current frame Fₖ. Nevertheless, due to noise disturbance and aperture problem of original signals, some error motion vectors can be estimated. For this reason, reliability of the estimated initial motion vector BMVₖ(m,n) is evaluated by the reliability evaluating unit 20.

The reliability evaluating unit 20 according to an exemplary embodiment of the present invention includes a periodic block detecting unit 21, a smoothing block detecting unit 23, and a reliability generating unit 25.

Most error vectors are generated in smoothing areas and areas having a periodic structure. Accordingly, in an exemplary embodiment, the periodic block detecting unit 21 for detecting periodic areas having a periodic structure and the smoothing block detecting unit 23 for detecting smoothing areas are provided.

Also, according to the detection results, the reliability generating unit 25 generates and outputs a reliability matrix Cₖ. In an exemplary implementation, the reliability matrix Cₖ(m,n), which represents reliability of a motion vector of each block, is initially set to 0. If it is determined that a reference block Bₖ(m,n) is a smoothing block, its reliability matrix Cₖ(m,n) is set to 1. If it is determined that the reference block Bₖ(m,n) is a block having a periodic structure, its reliability matrix Cₖ(m,n) is set to 2.

Hereinafter, an exemplary smoothing block detecting method performed by the smoothing block detecting unit 23, according to an exemplary embodiment of the present invention, will be described.

It is determined by two parameters Sₑ and S_{d} whether a reference block is a smoothing block. The parameter Sₑ is the number of edge pixels and the edge pixel means that a difference between the gray level of the current pixel and the gray level of one of its neighboring pixels is greater than a reference value. Also, the parameter S_{d} is a sum of differences between the gray level of each pixel and the gray levels of the left and lower neighboring pixels of the pixel in the same block. In the current block Bₖ(m,n), pixels are defined as the following Equation 3.
{Pₘ(i,j)|0≦i≦M_{b}−1,0≦j≦N_{b}−1}. (3)

The parameters Sₑ and S_{d} are calculated by the following Equation 4.

$${S}_{e} = {\sum }_{{0 \leq i \leq {M}_{b} - 2}_{0 \leq j \leq {N}_{b} - 2}} f ( i , j ) \\ f ( i , j ) = \{ \begin{matrix}1 & if \vert {P}_{mn} ( i , j ) - {P}_{mn} ( i , j + 1 ) \vert + \vert {P}_{mn} ( i , j ) - {P}_{mn} ( i + 1 , j ) \vert > Thr 1 \\ 0 & else\end{matrix} \\ {S}_{d} = {\sum }_{{0 \leq i \leq {M}_{b} - 2}_{0 \leq j \leq {N}_{b} - 2}} ( \vert {P}_{mn} ( i , j ) - {P}_{mn} ( i , j + 1 ) \vert + \vert {P}_{mn} ( i , j ) - {P}_{mn} ( i + 1 , j ) \vert ) \qquad ( 4 )$$

where, Thr1 represents the reference value. If the parameter Sₑ is smaller than another reference value Thr2 and the parameter S_{d} is smaller than another reference, value Thr3, it is determined that the current block Bₖ(m,n) is a smoothing block and the reliability matrix Cₖ(m,n) is set to 1.

Hereinafter, a periodic block detecting method performed by the periodic block detecting unit 21, according to an exemplary embodiment of the present invention, will be described.

A block having a periodic structure is detected based on a SAD matrix of each block. The motion estimating unit 10 searches all possible candidate locations in a predetermined search range of the previous frame Fₖ₋₁, in order to detect a reference block matched to each block Bₖ (m,n) of the current frame Fₖ according to the FSBM algorithm. That is, the motion estimating unit 10 configures a SAD matrix where SAD values are recorded in the all possible candidate locations, with respect to each block Bₖ(m,n), and provides the SAD matrix to the periodic block detecting unit 21.

A SAD matrix SAD_{C} of the current block Bₖ(m,n) is defined as the following Equation 5.
{SAD_{c}(p,q)|0≦p≦Mₛ−1,0≦q≦N_{b}−1} (5)

The minimum value of the SAD matrix SAD_{C} is denoted by SAD_{C}(p₀,q₀). A block having a periodic structure can derive a minimum SAD value very similar to the minimum SAD matrix value SAD_{C}(p₀,q₀). If such a minimum SAD value is detected, it is determined that the current block Bₖ(m,n) is a block having a periodic structure.

That is, the periodic block detecting unit 23 checks all values of the SAD matrix SAD_{C} in order to determine whether a local minimum SAD value is derived from a periodic structure. If a value in the SAD matrix SAD_{C}, noted as SAD_{C}(p₁, q₁), satisfies the following four inequalities, it is determined that the corresponding block is a periodic block. Accordingly, its reliability matrix Cₖ(m,n) is set to 2.
1)|SAD_{c}(p₁,q₁)−SAD_{c}(p₀,q₀)|<Thr4;
2)|p₁−p₀|+|q₁−q₀|>Thr5;
3)SAD_{c}(p₁,q₁)<SAD_{c}(p₁−1,q₁),SAD_{c}(p₁,q₁)<SAD_{c}(p₁,q₁−1),
SAD_{c}(p₁,q₁)<SAD_{c}(p₁+1,q₁),SAD_{c}(p₁,q₁)<SAD_{c}(p₁,q₁+1);
4)SAD_{c}((p₁+p₀)/2,(q₁+q₀)/2)>Thr6*SAD_{c}(p₀,q₀); (6)

where, Thr4, Thr5 and Thr6 represent reference values.

The reliability evaluation data is used to decide a final motion vector in the following frame interpolation.

As described above, an initial motion vector of each block in a current frame is estimated by the motion estimating unit 10 and the reliability of the motion vector is evaluated by the reliability evaluating unit 20. The frame interpolating unit 30 interpolates an intermediate frame to be inserted between the current frame and the previous frame, on the basis of the initial motion vector and the reliability evaluation data.

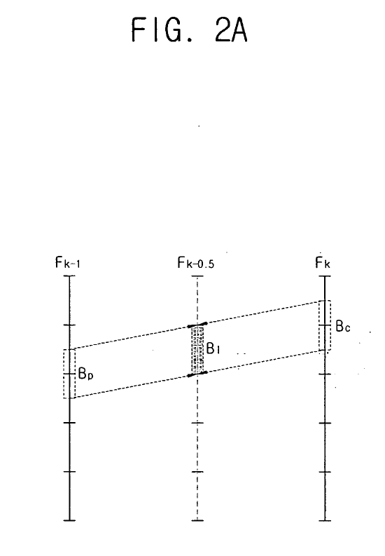

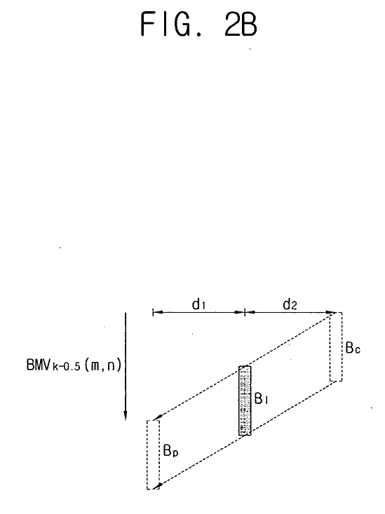

Hereinafter, the frame interpolating unit 30 will be described with reference to FIGS. 2A and 2B. As illustrated in FIG. 2A, the frame interpolating unit 30 uses a current frame Fₖ and the previous frame Fₖ₋₁ as reference frames to interpolate new intermediate frame F_{k-0.5} on the basis of an initial motion field BMVₖ.

At this time, the frame interpolating unit 30 applies a symmetrical interpolation mode to perform interpolation. In an exemplary implementation, the motion estimating unit 10 uses an inverse matching method as a motion estimation method. Also, as an interpolation method, a symmetrical matching method is used. The symmetrical interpolation mode divides the intermediate frame F_{k-0.5} into a plurality of rectangular blocks B_{k-0.5}(m,n) not overlapping, and estimates a motion vector BMV_{k-0.5}(m,n) of each block B_{k-0.5}(m,n) by using the current frame Fₖ and the previous frame Fₖ₋₁ as reference frames.

As illustrated in FIG. 2A, the pixel value of the block B_{k-0.5}(m,n) is interpolated by two reference blocks B′ₖ₋₁(m,n) and B′ₖ(m,n) of the previous and current frames Fₖ₋₁ and Fₖ. In FIG. 2A, B₁ represents the block B_{k-0.5}(m,n) to be interpolated, B_{c} represents the reference block B′ₖ(m,n) of the current frame Fₖ, and Bₚ represents the reference block B′_{k-1.5}(m,n) of the previous frame Fₖ₋₁.

The locations of the reference blocks B′ₖ₋₁(m,n) and B′ₖ(m,n) are linearly decided according to the location of the block B_{k-0.5}(m,n), a motion vector BMV_{k-0.5}(m,n), a time difference d₁ between the previous frame Fₖ₋₁ and the interpolated frame F_{k-0.5}, and a time difference d₂ between the interpolated frame F_{k-0.5} and the current frame Fₖ.

FIG. 2B is a view for explaining a relationship between the location of the block B_{k-0.5}(m,n) and the locations of the reference blocks B′ₖ₋₁(m,n) and B′ₖ(m,n). The locations of the respective blocks can be calculated by the following Equation 7.

$${POS}_{c} = {POS}_{1} - \frac{{d}_{2}}{{d}_{1} + {d}_{2}} {BMV}_{k - 0.5} ( m , n ) \\ {POS}_{p} = {POS}_{1} + \frac{{d}_{1}}{{d}_{1} + {d}_{2}} {BMV}_{k - 0.5} ( m , n ) \qquad ( 7 )$$

where, POS_{I} represents the location of the block B_{I}, POS_{c} represents the location of the block B_{c}, and POSₚ represents the location of the block Bₚ. A SAD value between the reference blocks B′ₖ₋₁(m,n) and B′ₖ(m,n) is also referred to as a symmetrical matching SAD of the block B_{k-0.5}(m,n).

In the symmetrical interpolation mode, as illustrated in FIG. 2A, the block B_{k-0.5}(m,n) is positioned on a divided rectangular block, however, the reference blocks B′ₖ₋₁(m,n) and B′ₖ(m,n) may not be positioned on divided rectangular blocks. Thus, all pixels in the intermediate block F_{k-0.5} can be interpolated from top to bottom. In the symmetrical interpolation mode, the motion vector BMV_{k-0.5}(m,n) should be decided. However, due to a time gap between the current frame Fₖ and the previous frame Fₖ₋₁, the motion vector BMV_{k-0.5}(m,n) can be different from the motion vector BMVₖ(m,n). If the motion vector BMVₖ(m,n) is directly used as the motion vector BMV_{k-0.5}(m,n), blocking artifact will appear.

Hereinafter, the frame interpolating unit 30 according to an embodiment of the present invention will be described in detail.

As illustrated in FIG. 1, the frame interpolating unit 30 includes a motion selecting unit 40 for deciding a final motion vector on the basis of an initial motion vector and reliability evaluation data, and a motion compensating unit 50 for compensating for a motion according to the decided final motion vector.

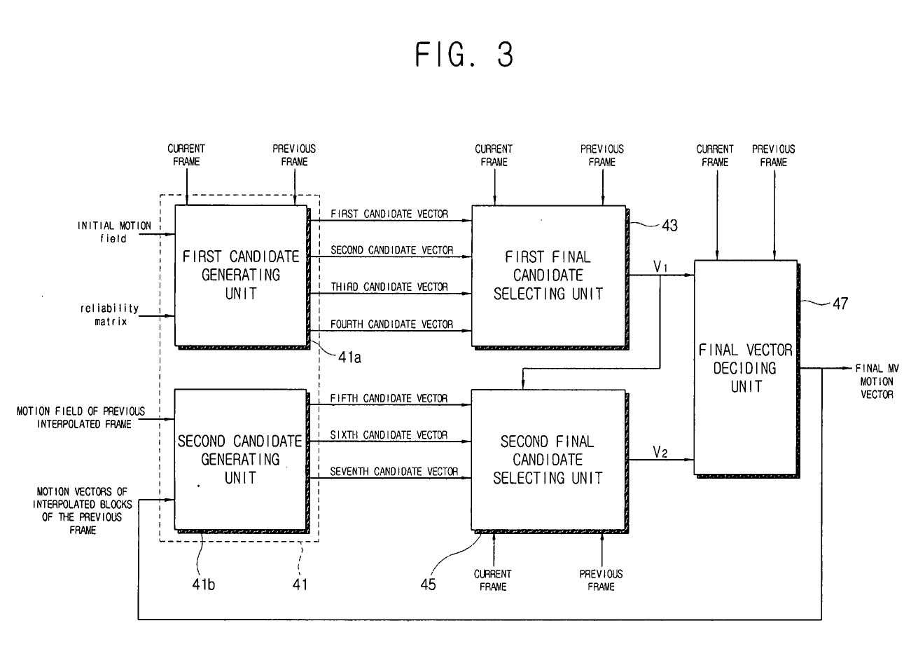

In an exemplary embodiment, the motion selecting unit 40 generates 7 candidate vectors on the basis of a motion vector BMVₖ and a reliability matrix Cₖ, and then selects an optimal candidate vector for a motion vector BMVₖ₋₁ (m,n), among the 7 candidate vectors. This will be described in detail with reference to FIGS. 3, 4, and 5 below.

Referring to FIG. 3, the motion selecting unit 40 includes a candidate generating unit 41 for generating a plurality of candidate vectors. The candidate generating unit 41 includes a first candidate generating unit 41a and a second candidate generating unit 41b.

The first candidate generating unit 41a generates 4 candidate vectors from an initial motion field BMVₖ. The 4 candidate vectors are respectively selected from different parts of the initial motion field BMVₖ. The second candidate generating unit 41b generates 3 candidate vectors from motion vectors of the interpolated blocks of the previous frame Fₖ₋₁ and a motion field, noted as BMV_{k-1.5}(m,n), of the previously interpolated frame F_{k-1.5}.

Hereinafter, a method in which the first candidate generating unit 41a and the second candidate generating unit 41b generate the 7 candidate vectors, will be described in detail.

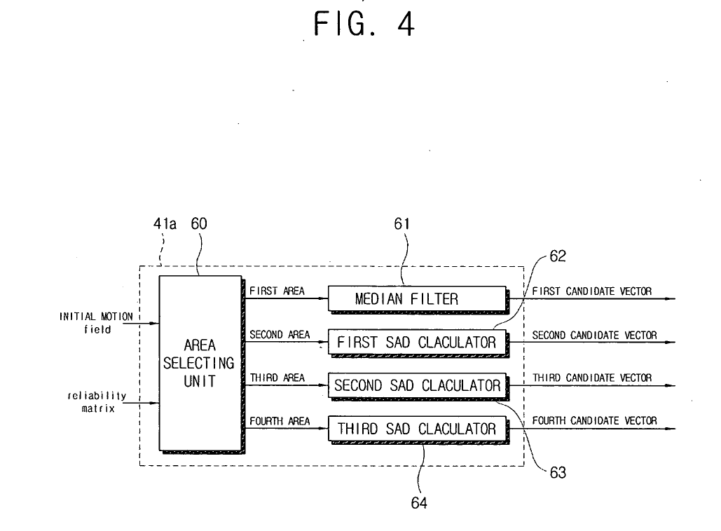

The first candidate generating unit 41a, as illustrated in FIG. 4, includes an area selecting unit 60, a median filter 61, a first SAD calculator 62, a second SAD calculator 63, and a third SAD calculator 64.

In an exemplary implementation, the area selecting unit 60 selects areas for calculating the respective candidate vectors from parts of an initial motion field BMVₖ.

A first candidate vector CV₁ is calculated by performing median-filtering on initial motion vectors in the median filter 61, in a first area SP₁ defined as the following range, which is a part of the initial motion field BMVₖ, selected by the area selecting unit 60.
{BMVₖ(m+x,n+y)εSP₁|−2≦x≦2,−2≦y≦2} (8)

where all motion vectors have two components; a vertical displacement component and a horizontal displacement component. Accordingly, the median filter 61 for filtering motion vectors must be a 2-component vector filter. In an exemplary embodiment, the 2-component vector filter can substitute for two 1-component median filters, that is a first 1-component median filter corresponding to the vertical displacement component and second a 1-component median filter corresponding to the horizontal displacement component.

The two reference blocks B′ₖ₋₁(m,n) and B′ₖ(m,n) for the block B_{k-0.5}(m,n) are searched from the previous frame Fₖ₋₁ and the current frame Fₖ, according to the first candidate vector CV₁. The locations of the reference blocks B′ₖ₋₁(m,n) and B′ₖ(m,n) are decided according to the method described above with reference to FIG. 2B. Then, a symmetrical matching SAD between the reference blocks B′ₖ₋₁(m,n) and B′ₖ(m,n) is calculated and noted as SAD_{c1}.

A second candidate vector CV₂ is selected from a second area SP′₁ which is a part of the first area SP₁ selected by the area selecting unit 60. In an exemplary implementation, the second area SP′₁ is defined as follows.
{BMVₖ(m+x,n+y)εSP′₁|BMVₖ(m+x,n+y)εSP₁,Cₖ(m+x,n+y)=0,−2≦x≦2,−2≦y≦2} (9)

Motion vectors in the second area SP′₁ belong to the first area SP₁ and it is determined that the motion vectors are reliable. This is because Cₖ(m+x,n+y)=0 means a block which is not a periodic block and is not in a smoothing area. A method of selecting the second candidate vector CV₂ from the second-area Sp′₁ is to minimize a symmetrical matching SAD of the block B_{k-0.5}(m,n). That is, the second candidate vector CV₂ among the motion vectors in the second area SP′1 is one among vectors which minimize a SAD between the reference blocks B′ₖ₋₁(m,n) and B′ₖ(m,n). A minimum symmetrical matching SAD thereof is denoted by SAD_{C2}.

A third candidate vector CV₃ is selected from a third area having a different initial motion vector BMVₖ by the area selecting unit 60, and the third area is denoted by SP₂. The third candidate vector CV₃ is defined as follows.
{BMVₖ(m+x,n+y)εSP₂|−1≦x≦1,−1≦y≦1} (10)

A method of selecting the third candidate vector CV₃ from the third area SP₂ is to minimize a symmetrical matching SAD of the block B_{k-0.5}(m,n). Then, a SAD value between the reference blocks B′ₖ₋₁(m,n) and B′ₖ(m,n) is calculated according to the third candidate vector CV₃ and denoted by SAD_{C3}.

A fourth candidate vector CV₄ is selected from a fourth area SP′₂ which is a part of the third area SP₂ selected by the area selecting unit 60. The fourth area SP′₂ is defined as follows.
{BMVₖ(m+x,n+y)εSP′₂|BMVₖ(m+x,n+y)εSP₂,Cₖ(m+x,n+y)=0,−1≦x≦1,−1≦y≦1} (11)

The number of motion vectors is denoted by K_{C4}. A method of selecting the fourth candidate vector CV₄ from the fourth area SP′₂ is to minimize a symmetrical matching SAD of the block B_{k-0.5}(m,n). Then, a SAD value between the reference blocks B′ₖ₋₁(m,n) and B′ₖ(m,n) is calculated according to the fourth candidate vector CV₄ and denoted by SAD_{C4}.

As illustrated in FIG. 3, a fifth candidate vector CV₅, a sixth candidate vector CV₆, and a seventh candidate vector CV₇ are selected by the second candidate generating unit 41b.

In an exemplary implementation, the fifth candidate vector CV₅ is a motion vector of the left adjacent block of the block B_{k-0.5}(m,n). That is, the fifth vector CV₅ corresponds to a motion vector BMV_{k-0.5}(m,n−1). The sixth candidate vector CV₆ is a motion vector of the upper adjacent block of the block B_{k-0.5}(m,n). That is, the sixth vector CV₆ corresponds to a motion vector BMV_{k-0.5}(m−1,n).

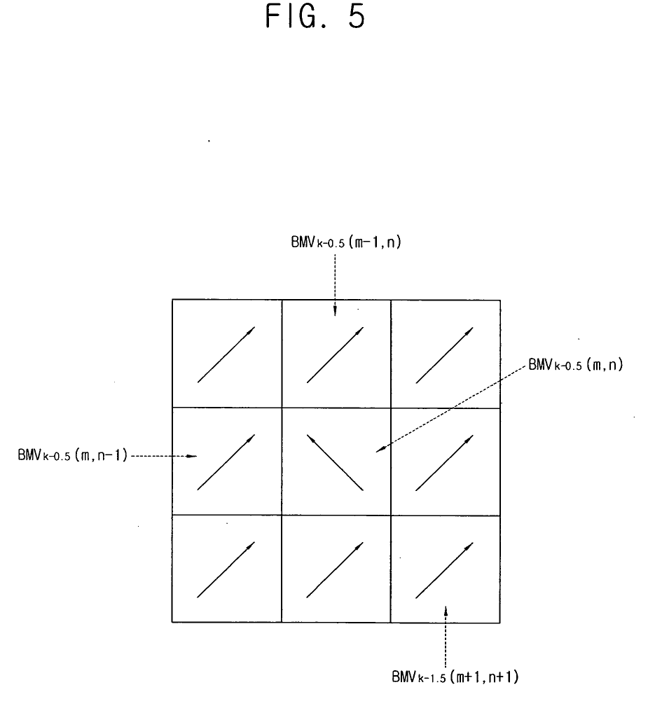

The seventh candidate vector CV₇ is a motion vector of the lower and right adjacent block of the block B_{k-0.5}(m,n) in the previous interpolation frame. That is, the seventh candidate vector CV₇ corresponds to a motion vector BMV_{k-1.5}(m+1,n+1). FIG. 5 illustrates a location relationship between the motion vectors BMV_{k-0.5}(m,n−1), BMV_{k-0.5}(m,n−1), BMV_{k-0.5}(m−1,n), and BMV_{k-1.5}(m+1,n+1).

One of the first through fourth candidate vectors CV₁, CV₂, CV₃, and CV₄ is selected as a first final candidate motion vector V₁ by a first final candidate selecting unit 43. The first final candidate motion vector V₁ is selected as follows.
if (SAD_{C1}<Thr7) or (SAD_{C1}<SAD_{C3}+Thr8),V₁=CV₁;
else if (K_{C4}<5) and ((SAD_{C2}<Thr7) or (SAD_{C2}<SAD_{C2}+Thr8)),V₁=CV₂;
else if (K_{C4}>5) and ((SAD_{C4}<Thr7) or (SAD_{C4}<SAD_{C3}+Thr8)),V₁=CV₄;
else V₁=CV₃; (12)

Thr7 and Thr8 represent threshold values. A symmetrical matching SAD value regarding the first final candidate motion vector V₁ is denoted by SAD_{V1}. For example, if the first final candidate motion vector V₁ is equal to the third candidate vector CV₃, SAD_{V1} is equal to SAD_{C3}.

Also, one of the fifth, sixth, and seventh candidate vectors CV₅, CV₆, and CV₇ is selected as a second final candidate motion vector V₂ by the second final candidate selecting unit 45. A method of selecting the second final candidate motion vector V₂ is to select one of vectors which minimize a symmetrical matching SAD value between the reference blocks B′ₖ₋₁(m,n) and B′ₖ(m,n) of the block B_{k-0.5}(m,n). A SAD value regarding the second final candidate motion vector V₂ is denoted by SAD_{V2}. As a result, one of the vectors V₁ and V₂ is selected as a final motion vector BMV_{k-0.5}(m,n) by a final vector deciding unit 47. The final motion vector BMV_{k-0.5}(m,n) is selected as follows.
if (|V₁−CV₅|>Thr9) and (|V₁−CV₆|>Thr9) and (|V₁−CV₇|>Thr9)
and ((SAD_{V2}<Thr7) or (SAD_{V2}<SAD_{V1}+Thr8)),BMV_{k-0.5}(m,n)=V₂;
else BMV_{k-0.5}(m,n)=V₁; (13)

The final motion vector BMV_{k-0.5}(m,n) is used to interpolate the current interpolation block B_{k-0.5}(m,n). Accordingly, in the previous frame Fₖ₋₁ and the current frame Fₖ, a location between the reference blocks B′ₖ₋₁(m,n) and B′ₖ(m,n) is decided as a block B_{k-0.5}(m,n), and a symmetrical matching SAD between the reference blocks B′ₖ₋₁(m,n) and B′ₖ(m,n) is denoted by SAD_{V}.

Then, the current interpolation block B_{k-0.5}(m,n) is interpolated by the motion interpolating unit 50 as follows.
if (SAD_{V}<Thr10),B_{k-0.5}(m,n)=B′ₖ(m,n);
else B_{k-0.5}(m,n)=(B′ₖ(m,n)+B′ₖ₋₁(m,n))/2; (14)

For example, in the interpolation frame F_{k-0.5}, all blocks B_{k-0.5}(m,n) are interpolated by the motion estimation method and the motion interpolation method as described above.

As described above, according to exemplary embodiments of the present invention, there are provided a frame interpolator, a frame interpolation method, and a motion reliability evaluator, which are capable of improving interpolation quality of frames and reducing a block artifact.

Although a few exemplary embodiments of the present invention have been shown and described, it will be appreciated by those skilled in the art that changes may be made in these embodiments without departing from the principles and spirit of the invention, the scope of which is defined in the appended claims and their equivalents.

What is claimed is:

1. A frame interpolator comprising:
a motion estimating unit dividing a current frame into a plurality of reference blocks, comparing the reference block with a search area set in a previous frame, and estimating an initial motion vector;
a reliability evaluating unit evaluating reliability of the initial motion vector and generating reliability evaluation data indicative of the evaluation result; and
a frame interpolating unit interpolating an intermediate frame to be inserted between the current frame and the previous frame on the basis of the initial motion vector and the reliability evaluation data.

2. The frame interpolator according to claim 1, wherein the reliability evaluating unit comprises:
a smoothing block detecting unit determining whether the reference block comprises a smoothing block;
a periodic block detecting unit determining whether the reference block comprises a periodic block; and
a reliability generating unit generating the reliability evaluation data according to the detection results.

3. The frame interpolator according to claim 2, wherein the smoothing block detecting unit determines whether the reference block comprises the smoothing block according to the following Equation:
$${S}_{e} < Thr 2 and {S}_{d} < Thr 3$$
$$\{ {P}_{mn} ( i , j ) \vert 0 \leq i \leq {M}_{b} - 1 , 0 \leq j \leq {N}_{b} - 1 \} . \\ where , \\ {S}_{e} = {\sum }_{{0 \leq i \leq {M}_{b} - 2}_{0 \leq j \leq {N}_{b} - 2}} f ( i , j ) , \\ f ( i , j ) = \{ \begin{matrix}1 & if \vert {P}_{mn} ( i , j ) - {P}_{mn} ( i , j + 1 ) \vert + \vert {P}_{mn} ( i , j ) - {P}_{mn} ( i + 1 , j ) \vert > Thr 1 \\ 0 & else\end{matrix} , \\ and \\ {S}_{d} = {\sum }_{{0 \leq i \leq {M}_{b} - 2}_{0 \leq j \leq {N}_{b} - 2}} ( \vert {P}_{mn} ( i , j ) - {P}_{mn} ( i , j + 1 ) \vert + \vert {P}_{mn} ( i , j ) - {P}_{mn} ( i + 1 , j ) \vert ) ,$$
wherein Thr1, Thr2, and Thr3 represent reference values.

4. The frame interpolator according to claim 2, wherein the periodic block detecting unit determines that the reference block comprises the periodic block if the following four inequalities are satisfied:
1)|SAD_{c}(p₁,q₁)−SAD_{c}(p₀,q₀)|<Thr4;
2)|p₁−p₀|+|q₁−q₀|>Thr5;
3)SAD_{c}(p₁,q₁)<SAD_{c}(p₁−1,q₁),SAD_{c}(p₁,q₁)<SAD_{c}(p₁,q₁−1),
SAD_{c}(p₁,q₁)<SAD_{c}(p₁+1,q₁),SAD_{c}(p₁,q₁)<SAD_{c}(p₁,q₁+1);
4)SAD_{c}((p₁+p₀)/2,(q₁+q₀)/2)>Thr6*SAD_{c}(p₀,q₀);
wherein Thr4, Thr5, and Thr6 represent reference values.

5. The frame interpolator according to claim 1, wherein the frame interpolating unit interpolates the intermediate frame according to a symmetrical block matching method.

6. The frame interpolator according to claim 5, wherein the frame interpolating unit comprises:
a motion selecting unit deciding a final motion vector on the basis of the initial motion vector and the reliability evaluation data; and
a motion compensating unit interpolating the intermediate frame to be inserted between the current frame and the previous frame according to the decided final motion vector.

7. The frame interpolator according to claim 6, wherein the motion selecting unit comprises a candidate generating unit for generating a plurality of candidate vectors on the basis of the initial motion vector and the reliability evaluation data.

8. The frame interpolator according to claim 7, wherein the candidate generating unit comprises:
a first candidate generating unit generating the plurality of candidate vectors on the basis of the initial motion vector and the reliability evaluation data; and
a second candidate generating unit generating the plurality of candidate vectors on the basis of motion vectors of previous-interpolated adjacent blocks and a motion field of a previously interpolated frame.

9. The frame interpolator according to claim 8, wherein the first candidate generating unit comprises:
an area selecting unit selecting a plurality of areas respectively corresponding to the plurality of candidate vectors in an initial motion vector field;
a median filter performing median-filtering on a first area of the selected plurality of areas, and generating a first candidate vector;
a first SAD calculator calculating a minimum SAD value from a second area of the selected plurality of areas, and generating a second candidate vector;
a second SAD calculator calculating a minimum SAD value from a third area of the selected plurality of area, and generating a third candidate vector; and
a third SAD calculator calculating a minimum SAD value from a fourth area of the selected plurality of areas, and generating a fourth candidate vector.

10. The frame interpolator according to claim 9, wherein the first area is defined as follows:
{BMVₖ(m+x,n+y)εSP₁|−2≦x≦2,−2≦y≦2}
where BMVₖ represents the initial motion vector field, k represents a frame number, SP₁ represents the first area, and the coordination value (m+x,n+y) represents each location of upper and left pixels of the block.

11. The frame interpolator according to claim 10, wherein the second area is defined as follows:
{BMVₖ(m+x,n+y)εSP′₁|BMVₖ(m+x,n+y)εSP₁,Cₖ(m+x,n+y)=0,−2≦x≦2,−2≦y≦2}
where SP′₁ represents the second area, Cₖ(m+x,m+y)=0 means that the corresponding block is not in a smoothing area and is not in a periodic area, and the second area SP′₁ is a part of the first area SP₁.

12. The frame interpolator according to claim 11, wherein the third area is defined as follows:
{BMVₖ(m+x,n+y)εSP₂|−1≦x≦1,−1≦y≦1}
where SP₂ represents the third area.

13. The frame interpolator according to claim 12, wherein the fourth area is defined as follows:
{BMVₖ(m+x,n+y)εSP′₂|BMVₖ(m+x,n+y)εSP₂,Cₖ(m+x,n+y)=0,−1≦x≦1,−1≦y≦1}
where SP′₂ represents the fourth area, Cₖ(m+x,n+y)=0 means that the corresponding block is not in the smoothing area and is not in the periodic area, and SP′₂ is a part of the third area SP₂.

14. The frame interpolator according to claim 8, wherein the second candidate generating unit selects a motion vector of a left adjacent block of the reference block as a fifth candidate vector, selects a motion vector of an upper adjacent block of the reference block as a sixth candidate vector, and selects a motion vector of a lower and right adjacent block of the reference block as a seventh candidate vector in the previously interpolated frame.

15. The frame interpolator according to claim 14, wherein the motion selecting unit comprises:
a first final candidate selecting unit deciding one of the plurality of candidate vectors generated from the first candidate generating unit as a first final candidate vector, according to a first selection criterion;
a second final candidate selecting unit deciding one of the plurality of candidate vectors generated from the second candidate generating unit as a second final candidate vector, according to a second selection criterion; and
a final vector deciding unit selecting one of the first final candidate vector and the second final candidate vector as a final motion vector, according to a third selection criterion.

16. The frame interpolator according to claim 15, wherein the first selection criterion is defined as follows:
if (SAD_{C1}<Thr7) or (SAD_{C1}<SAD_{C3}+Thr8),V₁=CV₁;
else if (K_{C4}<5) and ((SAD_{C2}<Thr7) or (SAD_{C2}<SAD_{C2}+Thr8)), V₁=CV₂;
else if (K_{C4}>5) and ((SAD_{C4}<Thr7) or (SAD_{C4}<SAD_{C3}+Thr8)),V₁=CV₄;
else V₁=CV₃;
where, SAD_{C1} represents a minimum SAD value by the first candidate vector, SAD_{C2} represents a minimum SAD value by the second candidate vector, SAD_{C3} represents a minimum SAD value by the third candidate vector, SAD_{C4} represents a minimum SAD value by the fourth candidate vector, K_{C4} is the number of motion vectors, Thr7 and Thr8 represent reference values, CV₁, CV₂, CV₃, and CV₄ respectively represent the first candidate vector, the second candidate vector, the third candidate vector, and the fourth candidate vector, and V₁ represents the first final candidate vector.

17. The frame interpolator according to claim 16, wherein the second selection criterion depends on a minimum SAD value according to a symmetrical block matching method.

18. The frame interpolator according to claim 17, wherein the third selection criterion is defined as follows:
if (|V₁−CV₅|>Thr9) and (|V₁−CV₆|>Thr9) and (|V₁−CV₇|>Thr9)
and ((SAD_{V2}<Thr7) or (SAD_{V2}<SAD_{V1}+Thr8)),BMV_{k-0.5}(m,n)=V₂;
else BMV_{k-0.5}(m,n)=V₁;
where, SAD_{C5} represents a minimum SAD value by the fifth candidate vector, SAD_{C6} represents a minimum SAD value by the sixth candidate vector, SAD_{C7} represents a minimum SAD value by the seventh candidate vector, Thr7, Thr8, and Thr9 represent reference values, CV₅, CV₆, and CV₇ respectively represent the fifth candidate vector, the sixth candidate vector, and the seventh candidate vector, V₁ represents the first final candidate vector, and V₂ represents the second final candidate vector.

19. The frame interpolator according to claim 18, wherein the frame interpolating unit interpolates the intermediate frame by the following Equation:
if (SAD_{V}<Thr10),B_{k-0.5}(m,n)=B′ₖ(m,n);
else B_{k-0.5}(m,n)=(B′ₖ(m,n)+B′ₖ₋₁(m,n))/2;
where, SAV_{V} represents a minimum SAD value by the final motion vector, Thr10 represents a reference value, B_{k-0.5}(m,n) represents a block to be interpolated, B′ₖ(m,n) represents a matching block of the current frame, and B′ₖ₋₁(m,n) represents a matching block of the previous frame.

20. The frame interpolator according to claim 1, wherein the motion estimating unit estimates the initial motion vector according to a full search block matching algorithm.

21. A frame interpolation method comprising:
dividing a current frame into a plurality of reference blocks, comparing the reference block with a predetermined search area set in a previous frame, and estimating an initial motion vector;
evaluating reliability of the initial motion vector and generating reliability evaluation data regarding the evaluation result; and
interpolating an intermediate frame to be inserted between the current frame and the previous frame on the basis of the initial motion vector and the reliability evaluation data.

22. The frame interpolation method according to claim 21, wherein the generating the reliability evaluation data comprises:
determining whether the reference block is a smoothing block;
determining whether the reference block is a periodic block; and
generating the reliability evaluation data according to the determined results.

23. The frame interpolation method according to claim 22, wherein, in the interpolating of the intermediate frame, the intermediate frame is interpolated according to a symmetrical block matching method.

24. The frame interpolation method according to claim 23, wherein the interpolating the intermediate frame comprises:
deciding a final motion vector on the basis of the reliability evaluation data; and
interpolating the intermediate frame to be inserted between the current frame and the previous frame according to the final motion vector.

25. The frame interpolation method according to claim 24, wherein the deciding the finial motion vector comprises:
generating a plurality of candidate vectors on the basis of the initial motion vector and the reliability evaluation data; and
deciding one of the plurality of candidate vectors as a final motion vector according to a criterion.

26. The frame interpolation method according to claim 25, wherein the generating the plurality of candidate vectors comprises:
generating a plurality of first candidate vectors on the basis of the initial motion vector and the reliability evaluation data; and
generating a plurality of second candidate vectors on the basis of motion vectors of previous-interpolated adjacent blocks and a motion field of a previously interpolated frame.

27. The frame interpolation method according to claim 26, wherein the generating the plurality of first candidate vectors comprises:
selecting a plurality of areas respectively corresponding to the plurality of candidate vectors in an initial motion vector field;
performing median-filtering on a first area of the selected plurality of the areas and generating a first candidate vector;
calculating a minimum SAD value from a second area of the selected plurality of the areas and generating a second candidate vector;
calculating a minimum SAD value from a third area of the selected plurality of the areas and generating a third candidate vector; and
calculating a minimum SAD value from the fourth area of the selected plurality of the areas and generating a fourth candidate vector.

28. The frame interpolation method according to claim 27, wherein the generating the plurality of second candidate vectors comprises:
selecting a motion vector of a left adjacent block of the reference block, as a fifth candidate vector;
selecting a motion vector of a upper adjacent block of the reference block, as a sixth candidate vector; and
selecting a motion vector of a lower and right adjacent block of the reference block, as a seventh candidate vector, in the previously interpolated frame.

29. The frame interpolation method according to claim 28, wherein the deciding the final motion vector comprises:
selecting one of the plurality of candidate vectors generated from the first candidate generating unit as a first final candidate vector, according to a first selection criterion;
selecting one of the plurality of candidate vectors generated from the second candidate generating unit as a second final candidate vector, according to a second selection criterion; and
deciding one of the first final candidate vector and the second candidate vector as the final motion vector, according to a third selection criterion.

30. A motion reliability evaluator comprising:
a motion estimating unit dividing a current frame into a plurality of reference blocks, comparing the reference block with a search area set in a previous frame, and estimating an initial motion vector;
a periodic block detecting unit determining whether the reference block comprises a periodic block; and
a reliability generating unit generating reliability evaluation data according to the determined result.

31. The motion reliability evaluator according to claim 30, wherein the periodic block detecting unit determines that the reference block is the periodic block if the following four inequalities are satisfied:
1)|SAD_{c}(p₁,q₁)−SAD_{c}(p₀,q₀)|<Thr4;
2)|p₁−p₀|+|q₁−q₀|>Thr5;
3)SAD_{c}(p₁,q₁)<SAD_{c}(p₁−1,q₁),SAD_{c}(p₁,q₁)<SAD_{c}(p₁,q₁−1),
SAD_{c}(p₁,q₁)<SAD_{c}(p₁+1,q₁),SAD_{c}(p₁,q₁)<SAD_{c}(p₁,q₁+1);
4)SAD_{c}((p₁+p₀)/2,(q₁+q₀)/2)>Thr6*SAD_{c}(p₀,q₀);
wherein Thr4, Thr5, and Thr6 represent reference values.

32. The motion reliability evaluator according to claim 30, further comprising a smoothing block detecting unit determining whether the reference block comprises a smoothing block.

33. The motion reliability evaluator according to claim 32, wherein the smoothing block detecting unit determines whether the reference block comprises the smoothing block, according to the following Equation:
$${S}_{e} < Thr 2 and {S}_{d} < Thr 3$$
$$\{ {P}_{mn} ( i , j ) \vert 0 \leq i \leq {M}_{b} - 1 , 0 \leq j \leq {N}_{b} - 1 \} . \\ where , \\ {S}_{e} = {\sum }_{{0 \leq i \leq {M}_{b} - 2}_{0 \leq j \leq {N}_{b} - 2}} f ( i , j )$$
$$f ( i , j ) = \{ \begin{matrix}1 & if \vert {P}_{mn} ( i , j ) - {P}_{mn} ( i , j + 1 ) \vert + \vert {P}_{mn} ( i , j ) - {P}_{mn} ( i + 1 , j ) \vert > Thr 1 \\ 0 & else\end{matrix} \\ and \\ {S}_{d} = {\sum }_{{0 \leq i \leq {M}_{b} - 2}_{0 \leq j \leq {N}_{b} - 2}} ( \vert {P}_{mn} ( i , j ) - {P}_{mn} ( i , j + 1 ) \vert + \vert {P}_{mn} ( i , j ) - {P}_{mn} ( i + 1 , j ) \vert )$$
wherein Thr1, Thr2, and Thr3 represent reference values.

34. The frame interpolator according to claim 1, wherein each reference block comprises a certain size.

35. The frame interpolation method according to claim 21, wherein each reference block comprises a certain size.

36. The motion reliability evaluator according to claim 30, wherein each reference block comprises a certain size.
